(19) United States
(12) Patent Application Publication
(10) Pub. No.: US 2004/0233284 A1
(43) Pub. Date: Nov. 25, 2004

(54) Apparatus and methods for providing surveillance data concerning a scene of interest to a user located at a remote location

(75) Inventors: Alan C. Lesesky, Charlotte, NC (US); Bobby Ray Weant, Rock Hill, SC (US); Brian Michael Lesesky, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Vehicle Enhancement Systems, Inc.

(21) Appl. No.: 10/268,003

(22) Filed: Oct. 9, 2002

Related U.S. Application Data
(60) Provisional application No. 60/328,174, filed on Oct. 9, 2001.

(51) Int. Cl. G08B 1/08

(52) U.S. Cl. 348/148

(57) ABSTRACT

The present invention provides apparatus and methods for providing visual information about a subject of interest. Specifically, the apparatus of the present invention includes a camera and light source for location at a point of interest. Pictures and/or video from the camera is transmitted to a remote location where it may be viewed by an interested party such that the user is not required to be in the vicinity of the area of interest to collect observations. The apparatus may use wireless communication, such as satellite, RF, and/or IR technology to transmit the data from the camera to the remote location. Further, the apparatus may include sensors for sensing characteristics of the environment surrounding. These environmental characteristics can be transmitted to the remote location or used triggering operation of the camera.

### CROSS-REFERENCE TO RELATED APPLICATIONS

The present application claims priority from U.S. Provisional Application Ser. No. 60/328,174 entitled APPARATUS AND METHODS FOR PROVIDING SURVEILLANCE DATA CONCERNING A SCENE OF INTEREST TO A USER LOCATED AT A REMOTE LOCATION, filed Oct. 9, 2001, the contents of which are incorporated herein by reference.

### BACKGROUND OF THE INVENTION

1. Field of the Invention

This invention relates to surveillance equipment used to gather video data and transmit the data to a remote location for monitoring.

2. Description of Related Art

Shipment of goods is a multi-billion dollar industry involving many types of transportation vehicles from the most common, which is tractor trailers, to air planes, ships, and trains. Further, many shipping companies maintain a large fleet of vehicles that are dispersed throughout the country and world for moving goods from place to place. These companies also include a large staff of employees whose job is to handle the logistics of shipment routes, capacity of vehicles, and the number of vehicles in a particular vicinity capable of hauling and delivering goods.

Given the cost of owning and operating vehicles such as tractor/trailers, it is important that each vehicle is efficiently used in the shipping process. Allowing vehicles to remain idle for an extended period of time can negatively affect shipping schedules and cost. For example, in the tractor/trailer industry, trailers are typically filled and then towed to various places for delivery. In some instances, the trailers are not immediately unloaded. Instead, they are disconnected from the tractor and left on-sight until they are either gradually unloaded or unloaded at a later date. This practice allows the tractor to immediately pick up an empty trailer for a next load, instead of waiting for unloading of the trailer. Further, the trailer may act as a temporary storage sight for the goods. A similar process is used with the boxcars of a train.

Although this practice does offer some advantages, there are some drawbacks. Specifically, the trailer or boxcar may be located at a remote location from the physical staff members of the logistics department. As such, it is difficult to determine when the trailer or boxcar is empty and ready for reloading without sending someone to the vehicle. For example, there are instances in which the only way to make this determination is to actually send some one to the trailer or boxcar and perform a visual check.

Many companies in the shipping industry are recognizing the need for tracking of their vehicles. For this reason, several systems have been developed that use global positioning systems (GPS) resident on the vehicles to indicate the vehicle's position. A communication system associated with the GPS system transmits location information to a central facility, where it can be accessed by the owner of the vehicle. These systems began as mere tracking devices, but are now expanding to provide more real time information about the vehicles. For example, both Qualcomm Corp.™ and Waveburst Communication, Inc.™ have developed satellite-based communication systems that provide not only position information about a vehicle but also provide several different operation indicators pertaining to the vehicle.

With the advent of this communication technology, systems have also been developed to provide indications of the current capacity of a vehicle. For example, one system uses weight sensors connected to the suspension of the vehicle. The system compares the sensed weight of the vehicle with the known empty weight of the vehicle. When these two weights are approximately equal, the system provides an indication that the vehicle is empty.

There are some drawbacks with this approach, however. For example, goods are sometimes light in weight compared to their size, such that the goods do not significantly increase the overall weight of the vehicle. In other words, the vehicle may be filled to capacity without much change in the weight of the vehicle. As the vehicle is emptied overtime, the overall weight may fall into the weight tolerances of the sensing system, such that the vehicle is indicated as empty, when in fact, it still includes several items. This problem is especially acute when the goods are fairly large in dimension but light in weight. False indications that a vehicle is empty may needlessly waste time and money to determine only after the vehicle is physically inspected that it is not available for use.

An alternative to this weight system is based on sonic transceivers. RandTEC, Inc.™ has a developed a system that uses a group of sonic transceivers located at various positions within the vehicle. The system controls the transceivers to output signals, which are reflected by cargo in the vehicle. Based on the reflected signals, the system determines whether the vehicle still contains goods. This system, however, requires multiple transceivers and wiring, which can be expensive to install and maintain. Further, the system typically only provides an indication that there are items in the vehicle and does not provide information concerning the available capacity of the vehicle.

In addition to concerns with determining the current capacity of a vehicle, there are also concerns with theft of goods from a vehicle. As stated, vehicles such as trailers and boxcars are sometimes parked for a period of time in a lot for future unloading. The vehicles may be situated in unsecured areas where they may be robbed or vandalized. Delivery vehicles are also susceptible to robbery. Specifically, the user of a delivery vehicle may be away from the vehicle for an extended time delivering goods from the vehicle to a recipient. In these instances, sometimes the vehicle is left open for convenience of the user making the vehicle a target for theft.

In addition to current capacity concerns and theft protection, there are also general safety issues with many vehicles. Specifically, vehicles such as tractor/trailers are operated on the highways, where in many cases they are the largest vehicles on the road. Because of the vehicle's size, there are many areas of the vehicle that have blind spots, such as the rear and sides of the vehicle. The operator must generally rely on only the side mirrors of the vehicle to assess the proximity of other vehicles and objects. It is not uncommon for a vehicle such as a car to be positioned at a side of the vehicle in a spot that is not in view of the driver. It would be advantageous to provide a system that allows the operator of the vehicle access to various views surrounding the vehicle during operation.

### BRIEF SUMMARY OF THE INVENTION

The present invention provides apparatus and methods for providing visual information about a subject of interest. Specifically, the apparatus of the present invention includes a camera and light source for location at a point of interest. Pictures and/or video from the camera is transmitted to a remote location where it may be viewed by an interested party such that the user is not required to be in the vicinity of the area of interest to collect observations.

For example, in one embodiment, the apparatus is used with a vehicle to provide information to someone who is remote from the vehicle. Specifically, the present invention includes a camera that can be used to take either still shots or continuous video. The camera is placed at a position of interest on the vehicle. Associated with the camera is a communication system for communicating the information collected by the camera to an interested party. As such, information concerning the vehicle can be ascertained without requiring the user to physically inspect the vehicle.

The apparatus and method of the present invention have several uses. For example, the apparatus may be positioned on the interior of vehicle so as to provide information concerning whether the vehicle is empty of goods. In this instance, the camera takes pictures of the interior of the vehicle and transmits them via a communication system to a central station. These pictures are then made accessible to the owner of the vehicle. By merely accessing this information the user can determine visually whether the vehicle is empty and available for new shipments.

The apparatus of the present invention may also be used as a security system. In this embodiment, the apparatus may be placed at any place on the vehicle. The apparatus includes a sensor, such as a motion detection sensor or a sensor connected to a door latch, hood, gas cap, etc. of the vehicle. When the sensor is activated, the camera takes either several still photos or a continuous video. These pictures or video are then transmitted to a user at a remote location, where they can be used to determine who entered the vehicle. In some instances, photo recognition software may be used in an attempt to identify an individual in a photo with a known criminal record.

The aspects of this embodiment of the present invention may be used for more general applications. Specifically, the apparatus of the present invention could be placed at any location of concern. Using a motion detector or similar device, the apparatus can capture picture or video if someone enters the area. These pictures and/or video can then be used to apprehend the individuals. This type of system could be used with security cameras about a facility or house, with the pictures and/or video being transmitted to the security administrators.

In addition to security, the apparatus and methods of the present invention can also be used as added safety measures to a vehicle. The apparatus of the present invention may be placed at various positions on the external portion of the vehicle. In these positions, the camera takes either still pictures or continuous video of the surrounding of the vehicle. These pictures and/or video are transmitted to a monitor in the vehicle, where they are viewed by the operator. Using these pictures and/or video, the operator can more safely operate the vehicle.

In some embodiments, the camera may be removed from the apparatus. This allows the user to take photos or video of the vehicle, which may be advantageous in the case of a mechanical failure of the vehicle. The pictures and/or video can then be transmitted to a mechanic located at a remote location. Viewing the pictures and/or video, the mechanic can diagnose problems with the vehicle.

As mentioned, in many cases the pictures and/or video are transmitted to a remote location for viewing. This may be accomplished in many ways. Specifically, the pictures and/or video may be transmitted via satellite, radio frequency (RF), or infrared (IR) technology to a computing system. The computing system may be a dedicated system owned by the user and configured to monitor the views from the camera or the central computing system could be a web-based server. In the latter instance, the user would have a secure account with the server and can access the pictures and/or video by logging in to the server.

Further, various communication technologies may be used in combination to transmit pictures and/or video. For example, in an embodiment in which a camera is used on a vehicle, the picture and/or video could be transmitted from the camera to a computer monitor or transmitter on the vehicle's existing wiring using power line carrier (PLC) technology as described in U.S. Pat. Nos. 6,127,939, 6,254,201, and 6,378,959. If the data is to be transmitted from the vehicle, the data may be transmitted via satellite, RF, or IR transmissions. In other embodiments, the picture and/or video may be transmitted directly from the camera to either a computer monitor on the truck, a satellite transmitter on the truck, and/or remote receiver. As mentioned, RF technology may be used for transmitting data. In some embodiments, BLUETOOTH or WI-FI (802.11b) is used for RF data transmission.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of an apparatus for providing surveillance data concerning a scene of interest to a user located at a remote according to one embodiment of the present invention.

FIG. 2A is a perspective view of the apparatus of the present invention in a housing according to one embodiment of the present invention.

FIGS. 2B and 2C respectively illustrate perspective views of the front and back portions of a housing used in conjunction with the some embodiments of the apparatus of the present invention.

FIG. 3 is a perspective view of embodiment of the present invention used in conjunction with a vehicle to provide surveillance data concerning the vehicle to a remote location according to one embodiment of the present invention.

FIG. 4 is a perspective view of embodiment of the present invention used in conjunction with a building or facility to provide surveillance data concerning the building or facility to a remote location according to one embodiment of the present invention.

FIG. 5 is a perspective view of embodiment of the present invention used in conjunction with a vehicle to provide surveillance data concerning the vehicle to a user of the vehicle according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

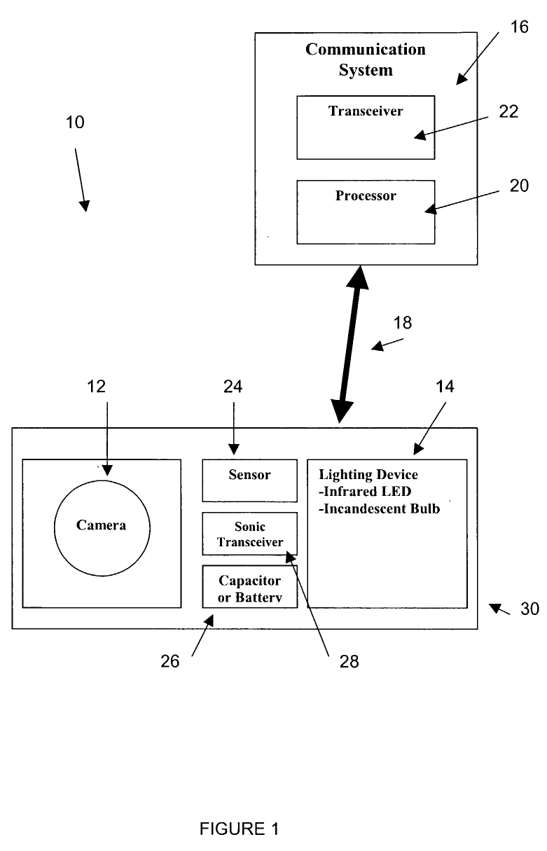

FIG. 1 illustrates a general embodiment of the apparatus 10 of the present invention. Specifically, the apparatus includes a camera 12 and a light source 14 located in a housing. Associated with the camera and light source is a communication system 16. The communication system is connected to the camera and light source via a communication link 18. The communication system is shown as a separate unit from the camera and light, but may be included in the same housing.

Importantly, the communication system includes a processor 20 for controlling the operation of the light source and camera. Further, the communication system includes a transceiver 22, which communicates information from the camera to a central computing system located at a remote station, not shown. The transceiver may be any one of a wide variety of transceivers, such as a satellite transceiver, IR transceiver, RF transceiver, etc. The information from the camera is provided either as pictures or video. Although pictures and video are discussed as separate terms herein, it is understood that the term “video” as used in the art typically encompasses picture data. This disclosure does not limit the broad use of the term video, and where video is used herein, it is meant to encompass picture data. The term “picture and/or data” is used in case a narrower interpretation of the term “video” is contemplated by the reader.

In some embodiments, the processor includes conversion software for converting the pictures into digital data, if it is not already in this form. The communication system may also compress, form into data packets, and encrypt the data before transmission. Further, depending on the type of camera implemented, the processor may include the proper software drivers for communicating with the camera. However, these software drivers could instead be located at the remote station in the central computing system or in the camera itself, and the communication system merely transmit the data as received from the camera. Furthermore, many cameras on the market today include communication ports for transmitting pictures and/or video in different forms to another system. For example, cameras may include USB ports, RS-232 ports, serial ports, firewire, IR, RF, blue tooth, etc. for transmitting the data to the communication system. In these instances, the communication system may merely be used to transmit the data to the remote station.

In general terms, the camera and light source are operated to take pictures and/or video of a scene of interest and provide these pictures and/or video via the communication system to the remote station. As mentioned, the action of the camera and light source may be controlled by the communication system to operate on command. In this instance, a user in the remote station may send a command to the communication system to activate the camera and light. The communication system, in turn, commands the camera and light to activate. The light source illuminates the scene of interest, while the camera takes pictures and/or video. The pictures and/or video may be stored locally in a storage device associated with the camera, or alternatively, the pictures and/or video may be transmitted to the communication system. The communication system, in turn, transmits the data via the transceiver 22 to the central computing system at the remote station.

With reference to FIG. 1, in some embodiments, the activation of the camera and light source may instead be controlled by a sensor 24 associated with the light source and camera. This sensor may be a motion sensor, which senses motion in the scene of interest and activates the camera and light source to record the movements. In some embodiments, however, the sensor may sense an event such as a door opening, hood opening, gas cap opening, etc. In this instance, the sensor may be connected to contacts associated with the door, such that when the door is opened, the sensor activates the light source and camera.

As illustrated, a communication link 18 exists between the communication system and camera and light source. It must be understood that this may be any type of communication link. It may be a physical wire connection or a wireless connection, such as an infrared (IR) or radio frequency (RF) connection. In the case of RF communication, BLUETOOTH or WI-FI (802.11b) communication techniques may be used. Using BLUETOOTH or WI-FI, the device could act as a wireless node on a network allowing for communication on a network.

For example, video cameras can be placed around the vehicle that broadcast pictures and/or video to an off board WI-FI (802.11b) reader and then broadcasted to a satellite and to a remote server /Internet. Siricomm is providing a WI-FI (802.11b) hot spot network for the trucking industry that allows driver, vehicle communication to a high speed wideband communications over to a local server/satellite disc located on the roof of the truck stop to a satellite a 48 mega bits per second. Video signals located on the vehicle (tractor/trailer using PLCV or video cables then transmitted to a remote location via WI-FI(802.11b) and to the Siricomm server and then to the internet will be used for security/maintenance/load information. www.siricomm.com website shows data communication at the WI-FI hot spot. Also, www.meshnetworks.com shows WI-FI networks in process for communications and video communications.

Further, the camera and light source could have an associated RF tag for controlling their operation. In this instance, the communication system 16 would include a polling device that polls the RF tag, thereby commanding the camera and light source to be activated. Further, in some embodiments, the apparatus of the present invention may use existing wiring of the vehicle and use power line carrier communicating PLC techniques for communication as described in U.S. Pat. Nos. 6,127,939, 6,254,201, and 6,378,959, which are hereby incorporated by reference.

In instances in which the connection is wireless, a transceiver will be associated with both the communication system 16 and the camera 12 and light source 14 to properly communicate information between the communication system and camera and light source. As discussed below, in some embodiments, the apparatus of the present invention is implemented in a vehicle such as a tractor/trailer combination. In these instances, the communication system and camera and light source may communicate using the standard protocol used by the vehicle. For example, current tractor/trailer combinations use SAE J1708/1587 and/or SAE J1939 communication protocol. In this instance, the data communicated between the camera and communication system would use this protocol.

With reference to FIG. 1, the light source and camera may receive power from different sources. For example, in embodiments in which the apparatus is connected to a vehicle or building, the light source and camera may receive power from the power lines associated with the vehicle or building. In some embodiments, however, the apparatus may include an internal energy source 26 such as a battery pack, capacitor network, or in some cases a solar energy pack.

As discussed above, the apparatus of the present invention transmits pictures and/or video to remote locations for viewing and analysis by a user. In some instances, after the user has viewed an initial picture and/or video of the scene surrounding the camera, the user may be more interested in knowing when changes occur to the scene as opposed to viewing additional pictures and/or video of the scene. Further, due to the large amount of data that must be transferred for pictures and/or video, subsequent pictures of the same scene may be expensive and time intensive to download. For example, the user may view an initial picture of the inside of a vehicle illustrating whether the vehicle still contains cargo. If the vehicle still contains cargo, the user may be interested in the future of not seeing a picture, but instead, determining whether the vehicle is now empty.

In light of this, in some embodiments, the apparatus 10 of the present invention may further include a sonic transceiver 28 located in the housing 30 with the camera 12 and light source 14. When the light source and camera are first initiated to take a picture, the sonic transceiver may also be activated to transmit a signal and receive a reflection of the signal. The reflected signal is a signature of the scene corresponding to the pictures and/or video taken by the camera. This signature may be stored with the pictures in a memory associated with the camera and sonic transceiver, or the signature data may be transmitted to the communication system 16 and eventually to the central computing system at a remote station. Importantly, in this embodiment, after the original pictures and/or video and the sonic signal are acquired, the sonic signal can be used later as an alternative method for determining if the vehicle is empty.

For example, a user may initially command that the camera and sonic transceiver acquire respective pictures and/or video and sonic readings. The user can view the pictures to determine whether the vehicle contains cargo. If the vehicle still includes cargo, for later inquiries, the user can command that only the sonic transceiver acquire new data. This new data file could then be compared either at the communication system 16 or at the central computing system to the initial signature sonic reading. If there is not a change in these readings, then the user does not have to pay for transmission of a subsequent set of pictures and/or video for the scene. In other words, if the sonic readings have not changed, the user can assume that the vehicle still includes cargo without having to take additional pictures and/or video of the vehicle. In other embodiments, an initial sonic reading may be taken at known conditions, such as when the vehicle is known to be empty. This initial reading could then be used in comparisons.

In an alternative embodiment, the apparatus and method of the present invention could instead use comparisons of the pictures and/or video taken at different times to determine whether there has been a change. Specifically, an initial set of pictures and/or video may be taken. These pictures and/or video can then be stored either in a storage device associated with the camera or in the communication system 16. These initial pictures and/or video can then be compared to later pictures and/or video taken of the scene. If there is no change in the pictures and/or video, instead of transmitting the new pictures and/or video, the communication system could transmit an indication of no change to the central computing system at the remote station. Alternatively, on the changed portions of the picture or video could be transmitted to update the current picture displayed at the central computing system.

The comparison of the original and new pictures and/or video can be performed using several different techniques. One simple technique is to compare the file sizes of the picture and/or video. If the file sizes are relatively the same within a given threshold, then it can be assumed that there has not been a change. More advanced systems can be implemented which actually compares the different portions of the pictures and/or video with the original pictures and/or videos. This may include analyzing the gray scale of various portions of the pictures and/or video to see if they correspond with the gray scale of same portions of the original pictures and/or video. Further, an analysis may be performed on a pixel-by-pixel basis to determine if there have been changes in the scene. Similar techniques can be used to determine whether an item in the scene captured by the camera has been moved within the picture. Pictures and/or video of the scene with the object positioned in a first place could be taken, and then subsequent pictures taken and analyzed to determine if the object has moved.

In addition to cameras, light sources, and sonic transceivers, the apparatus of the present invention may include other features that provide information concerning the area surrounding the camera. For example, the apparatus could include temperature sensors, atmospheric pressure sensors, etc. that provide information concerning the environment in the location of the camera. Similarly, the apparatus could include a fire and/or smoke detection sensor or an IR or far IR detection for heat or fire sensor. In this embodiment, if fire or smoke is detected, the sensor could send a signal to the communication system and on to the central computing system that an emergency is in progress.

As mentioned in the previous embodiments, the camera may be operated to take still shot pictures. The camera may be controlled to take either a single picture or a series of pictures. For example, the camera may be controlled to take a number of X pictures each time it is triggered to take pictures, with this picture creating a series of still photos of the scene within a short time period of delay between each picture.

In summary, the apparatus and methods of the present invention provides a camera and light source positioned at a scene of interest, which are connected either by a physical or wireless communication link to a communication system. The communication system can control the operation of the camera and light source or they can be controlled by sensor switches. Pictures and/or video taken by the camera can be stored locally or communicated to the communication system. The communication system can, in turn, via satellite, RF, IR, power line carrier communication (PLC), etc. communicate this data to a central computing station located at a remote location, where the pictures and video may be viewed by a user. The apparatus may also include other features such as a sonic transceiver to determine if changes in the scene have occurred, and environmental sensors, such as temperature, humidity, pressure, fire, smoke, etc. to provide indications concerning the environment surrounding the camera.

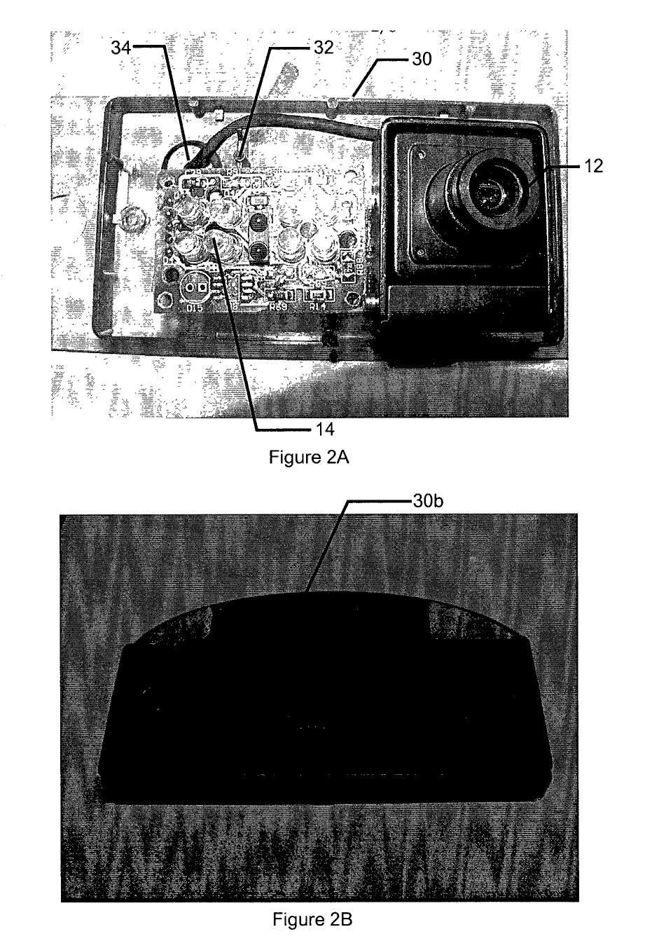

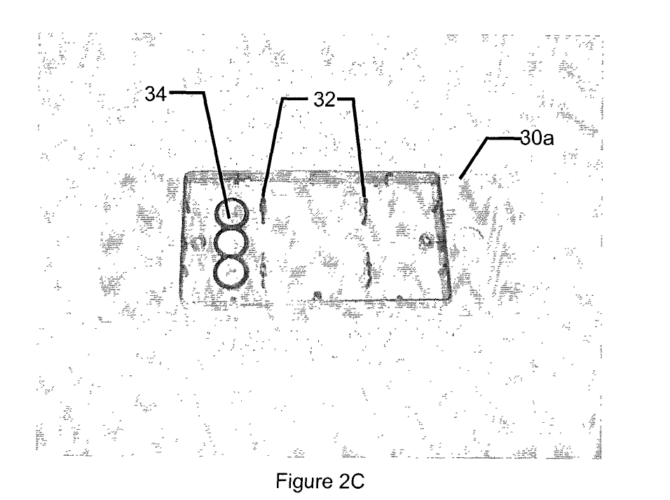

FIGS. 2A-2C illustrate one embodiment of the apparatus 10 of the present invention. Specifically, these figures illustrate a miniature camera 12 and low-voltage light source 14 incorporated into a housing 30 resembling a marker light typically used in the tractor/trailer industry. FIG. 2C illustrates the back portion 30a of the housing. This portion includes mounting posts 32 for supporting the light source and camera and holes 34 allowing for connection of external wiring.

The camera 12 may be any general camera. In some embodiments, the camera is an analog camera, while in others it is a digital camera. The camera may be capable of taking still shot photos and in some embodiments, continuous video. Further, the camera may incorporate a wide-angle lens such as a fisheye lens to take wide-angle pictures. Note that in this instance, the communication system or remote station will include fisheye reconversation software. It must be noted that although only one camera is illustrated, multiple cameras may be used in the apparatus of the present invention. Further, the camera could be either black and white or color. The camera may also include a speaker for recording sound to go along with the picture. Additionally, the apparatus of the present invention is designed to work with almost any type of camera, with the drivers for communicating with each camera located either in the communication system or the central computing system.

The light source is typically a low-voltage light source. In the embodiment illustrated in FIG. 2A-2C, the light source consists of a plurality of LEDs, preferably white, that are provided voltage from a low-level source. However, the light source could be of any type. For example, in one embodiment, the light source may be an incandescent light bulb.

FIG. 2B illustrates the outer cover 30b portion of the housing 30. In instances in which the apparatus of the present invention is used in a trailer/trailer combination, the outer covering resembles a common marker light. This is advantageous as it allows the apparatus of the present invention to remain discrete and undetected. As such, the apparatus is less likely to be noticed by a vandal. It must be understood that this outer covering could be formed into any shape to provide either an aesthetically pleasing or discrete unit.

Provided below are illustrations of the use of the apparatus and methods of the present invention in specific applications. It must be understood that these are only examples and by no means exhaustive.

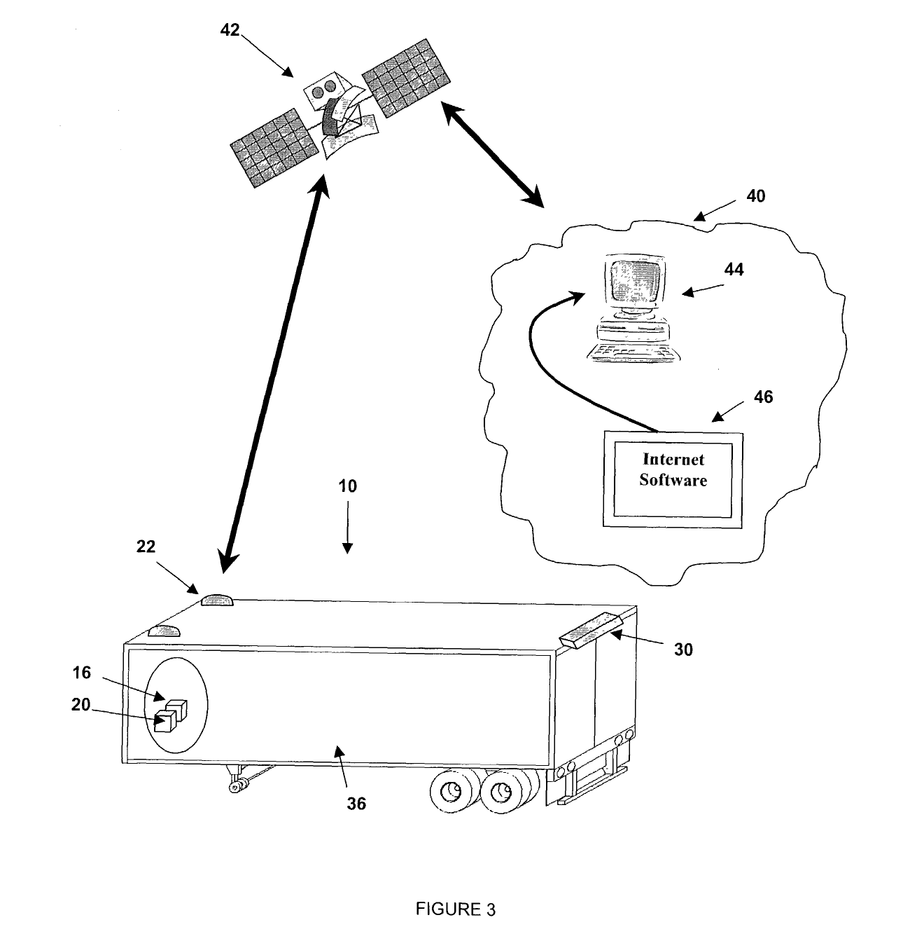

As discussed previously, one concern in the shipping industry is determining when a vehicle is empty and ready for use. To alleviate this problem, the present invention provides an apparatus and method that provide a user at a remote location with pictures and/or video of the inside of a vehicle so that the user may make a visual determination as to whether the vehicle is empty. Specifically, with reference to FIG. 3, in this embodiment, the apparatus 10 of the present invention includes a camera 12 and light source 14 located in a housing 30. The housing 30 is located in the trailer portion 36 of a tractor/trailer combination vehicle. As illustrated, the housing is preferably located at an upper position in the trailer and the camera and light source are directed along the inner length of the trailer. Located also on the vehicle are a communication system 16 and a transceiver 22. The camera and light source may be connected to the communication system 16 by various types of data links. The data link may be a physical link such as a dedicated wire or existing wiring in the vehicle. Alternatively, the data link may be wireless using IR or RF technology for communication. Some advantageous wireless embodiment use BLUETOOTH or WI-FI technology for communication, while one physical link embodiment uses power line carrier (PLC) techniques for data communication. Further, in either data communication link, SAE J1708/1587 and/or SAE J1939 communication protocol may be used for communication, which are standard protocols in the trucking industry.

The present invention also includes a system for communicating between the communication system 16 and a remote location 40. FIG. 3 illustrates use of satellite communication technology. In this embodiment, the transceiver 22 associated with the communication system 16 is capable of communicating data to and from a satellite 42, which in turn, is communicated to and from the remote location 40. As stated previously, Waveburst Communications, Inc. and Qualcomm Corp. have developed satellite communication systems for communication of data between a vehicle and a remote station. Such systems are contemplated for use with the apparatus and methods of the present invention.

It must be understood that satellite communication is only one means for communication between the communication system 16 and the remote station 40. Specifically, RF and IR technology can be used as alternative forms of communication. For example, the present invention could use cellular technology. Further, it could also use either stationary or handheld RF or IR readers. U.S. Pat. No. 6,064,299 issued on May 16, 2000 is incorporated herein by reference and discloses various handheld and stationary readers that are contemplated for use with the present invention. For example, a stationary reader could be positioned in a parking lot where the vehicles are located. The stationary reader could be used to communicate with the various vehicles located in the parking lot to capture pictures and/or video. The stationary reader could also be positioned on a roadside or in a truck stop setting to communicate with the vehicles as they travel past the reader. This embodiment would provide the user with information about a vehicle as it is in transit. Further, the communication system could be a portable handheld unit operated by a user to communicate with various vehicles in a parking lot or area. Once received by either the stationary or handheld unit, the data can then be provided to a central computing system 44 located at the remote station 40 for analysis. In some instances, a handheld unit can incorporate both the communication system and the central computing system for viewing pictures and/or video received from the camera on a monitor associated with the handheld unit. In some embodiments, the communication system 16 might act as a wireless node to a network by using RF communications, such as BLUETOOTH or WI-FI, or IR communications.

With reference again to FIG. 3, in this embodiment, the satellite communication system 42 transmits the pictures and/or video to a central computing system located at a remote location. The central computing system may be either a dedicated computer owned by the user or alternatively, a web-server. In the case of a web-sever, the user may access the web-server using Internet software 46 and view the pictures and/or video data. Further, via the web-server, the user may control the action of the camera to obtain pictures. A fee may be attached with the downloads of data by the user from the web-server.

In operation, the user via the central computing system may command the camera and light source to be activated to take pictures and/or video of the interior of the vehicle. These commands are sent via satellite communication 42 to the communication system 16, where they are relayed to the camera 12 and light source 14. Upon receiving the commands, the light source will be activated to provide proper lighting. The camera is activated and acquires pictures and/or video. These pictures and/or video may be stored in a storage device associated with the camera 12 or the communication system 16. Further, the pictures and/or video may be transmitted via the satellite or other communication means to the central computing system 44 at the remote station 42 for viewing and analysis by the user.

As discussed above, the apparatus of the present invention may include a sonic transceiver that acquires a base line reading for later use in determining whether the vehicle is empty in lieu of transmission of subsequent pictures and/or video. Further, the apparatus may include environmental sensors, such as temperature, pressure, humidity, fire and smoke, etc. to provide added data concerning the system. In addition, the apparatus may include event sensors such as door latch sensors, motion detect sensors, etc. that command the camera and light source to activate, as opposed to commands sent from the central computing station. These type sensors can be used in theft prevention applications. Further, in these applications, the pictures and/or video taken can be analyzed with recognition software that links pictures of known criminals with their identity.

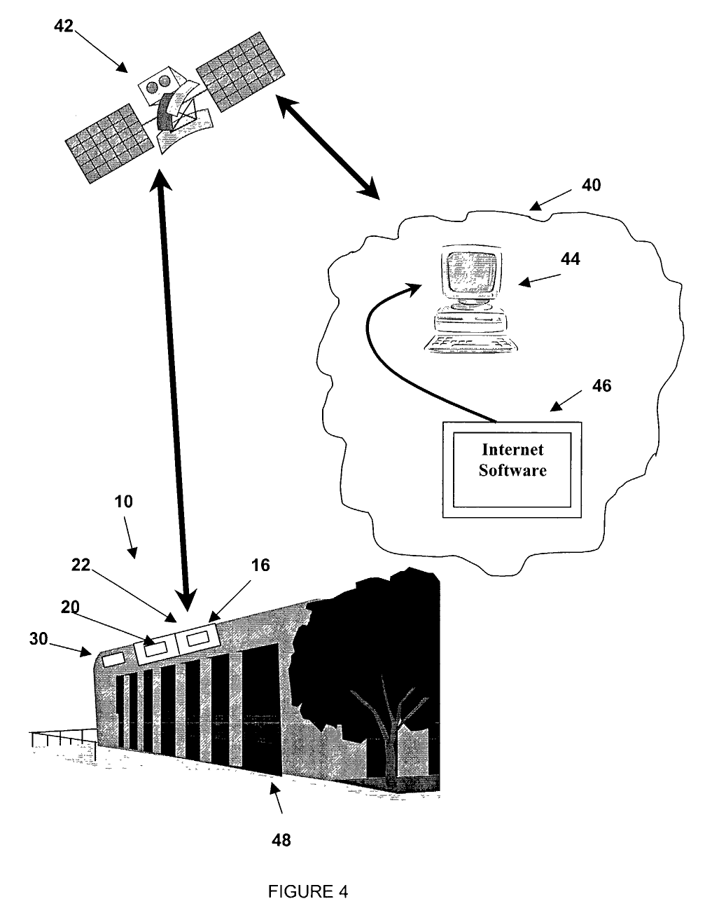

FIG. 4 illustrates a more general embodiment of the use of the apparatus and method of the present invention. In this embodiment, the apparatus and method of the present invention are used in a surveillance mode. Specifically, FIG. 4 illustrates the camera 12 and light source 14 in a housing 30 attached to the side of a building 48 or other structure. Similar to the embodiment illustrated in FIG. 3, a user at a remote location may periodically send commands to the camera to acquire pictures and/or video. Further, in other embodiments, the apparatus may include motion sensors or the like that activate the camera to acquire pictures and/or video when the sensors detect a change in the area surrounding the camera. In some embodiments, the camera may operate in a continuous mode to take continuous pictures or video. Further, the camera may be controlled via the remote computing system to collect data.

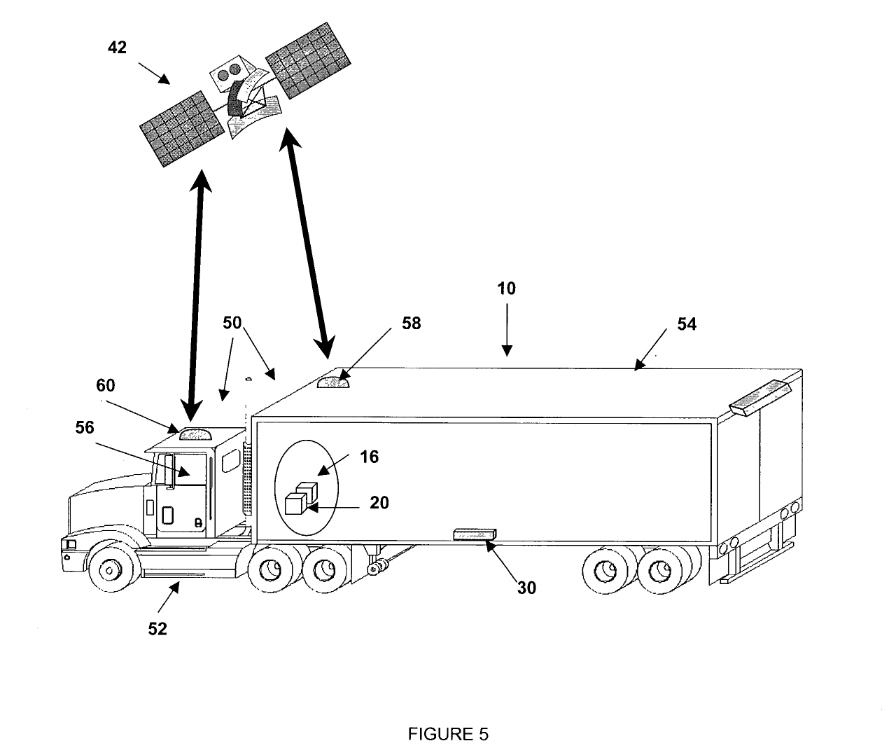

FIG. 5 provides yet another use of the apparatus and methods of the present invention. Specifically, in this embodiment, the apparatus is used as a safety measure on a vehicle. In this embodiment, the apparatus is used in conjunction with a tractor/trailer combination 50 consisting of a tractor 52 and a trailer 54. The camera 12 and light source 14 are located in a housing 30 connected to an area of the vehicle that is a blind spot to the operator of the vehicle. This could be on the side of the vehicle, back or front of the vehicle, under the vehicle, etc. Located in the cab of the tractor of the vehicle is a computing system 56 with a display. Pictures and/or video from the camera are displayed to the operator to assist the operator in driving the vehicle.

Important to this aspect of the present invention is the communication of commands from the computing system located on the tractor to the communication system and camera located on the trailer and transmission of the pictures and/or video from the camera to the computing system on the tractor. Specifically, there are well known problems with communication of data between the tractor and trailer of a tractor/trailer combination. Vibration and other environmental concerns frequently disrupt communications. The present invention overcomes this problem using various methods of communication.

Specifically, as illustrated in FIG. 5, in one embodiment, both the trailer and the tractor include transceivers, 58 and 60, respectively, for communicating data. In one embodiment, the transceivers are satellite transceivers. In this embodiment, data from the camera is communicated via the communicating system 16 and transceiver 58 to the satellite 42 and from the satellite to the computing system 56 via the transceiver 60 located on the tractor. In other embodiments, the transceivers are either RF or IR transceivers that communicate between each other using RF or IR signals, respectively. For example, BLUETOOTH or WI-FI communications could be used to transmit the data. Further, in one embodiment, the apparatus of the present invention uses existing wiring of the trailer and communicates the signals on the wiring across the glad hand connection between the tractor and trailer to the computing system located in the tractor and vice versa. In this embodiment, power line carrier (PLC) communicating techniques as described in U.S. Pat. Nos. 6,127,939, 6,254,201, and 6,378,959 can be used to communicate the data and SAE J1708/1587 and/or SAE J1939 communication protocols may be used.

In addition to the above embodiments, the present invention may also be used as aid to roadside assistance in case of an emergency or mechanical failure. Specifically, in some embodiments, the camera of the present invention is removable from the housing. The operator of the vehicle may use the camera to take pictures and/or video of scenes of interest about the vehicle, such as in the case of a mechanical break down. The pictures and/or video can then be transmitted to a remote station, where they can be viewed by a maintenance person. Based on these pictures, maintenance directions can be dictated to the operator of the vehicle in the field or proper parts can be sent to fix the vehicle in the field.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A surveillance system comprising:
a camera located at a point of interest;
a communication system associated with said camera having a transceiver for transmitting data received from said camera to a remote location; and
a computing system located at the remote location for receiving and displaying data acquired by said camera.

2. A surveillance system according to claim 1 further comprising a light source associated with said camera, wherein said light source provides lighting when said camera acquires data.

3. A surveillance system according to claim 1 further comprising a sensor associated with said camera for sensing changes in the environment surrounding said camera, wherein said sensor controls said camera to acquire data when it senses a change in the environment.

4. A surveillance system according to claim 1, wherein said camera acquires data on a continuous basis.

5. A surveillance system according to claim 2, wherein said communication system compares present data collected by said camera with data previously collected by said camera to determine whether the image captured by said camera has changed, and wherein if communication system determines there is not a difference between the comparison of the two data signals, said communication system does not transmit the present data acquired by said camera to said computing system.

6. A surveillance system according to claim 1 further comprising a data link connecting said camera to said communication system and a data link connecting said communication and said computing system.

7. A surveillance system according to claim 6, wherein at least one of said data links is wireless and transmits the data acquired from said camera in the form of infrared data.

8. A surveillance system according to claim 6, wherein at least one of said data links is wireless and transmits the data acquired from said camera in the form of radio frequency data.

9. A surveillance system according to claim 6, wherein at least one of said data links is wireless and transmits the data acquired from said camera in the form of BLUETOOTH.

10. A surveillance system according to claim 6, wherein at least one of said data links is wireless and transmits the data acquired from said camera in the form of WI-FI.

11. A surveillance system according to claim 6, wherein said data link between said communication device and said computing system is a satellite communication link.

12. A surveillance system for use with a vehicle comprising:
a camera located at a point of interest inside the vehicle and positioned to acquire data related to the a scene of interest inside the vehicle;
a communication system associated with said camera having a transceiver for transmitting data received from said camera to a remote location; and
a computing system located at the remote location for receiving and displaying data acquired by said camera, such that a user may view the scene of interest inside the vehicle at the remote location.

13. A surveillance system according to claim 12 further comprising a light source associated with said camera, wherein said light source provides lighting when said camera acquires data.

14. A surveillance system according to claim 12 further comprising a sensor associated with said camera for sensing changes in the environment surrounding said camera, wherein said sensor controls said camera to acquire data when it senses a change in the environment.

15. A surveillance system according to claim 12, wherein said sensor includes contacts connected to a door of the vehicle, and wherein when said door is opened, said sensor controls said camera to acquire data.

16. A surveillance system according to claim 12, wherein said sensor is a motion sensor, and wherein said sensor controls said camera to acquire data when it senses motion.

17. A surveillance system according to claim 12 further comprising a data link connecting said camera to said communication system and, a data link connecting said communication and said computing system.

18. A surveillance system according to claim 17, wherein at least one of said data links is wireless and transmits the data acquired from said camera in the form of infrared data.

19. A surveillance system according to claim 17, wherein at least one of said data links is wireless and transmits the data acquired from said camera in the form of radio frequency data.

20. A surveillance system according to claim 17, wherein at least one of said data links is wireless and transmits the data acquired from said camera in the form of BLUETOOTH.

21. A surveillance system according to claim 17, wherein at least one of said data links is wireless and transmits the data acquired from said camera in the form of WI-FI.

22. A surveillance system according to claim 17, wherein said data link between said communication device and said computing system is a satellite communication link.

23. A surveillance system according to claim 12 further comprising a sonic transceiver, wherein said sonic transceiver transmits a sonic signal and receives a reflection of the sonic signal, wherein the reflected signal is indicative of the environment about said camera.

24. A surveillance system according to claim 23, wherein said communication system compares different reflected signals received by said sonic transceiver at different times to determine whether the environment about said camera has changed, and wherein if communication system determines there is not a difference between the comparison of two reflected signals from said sonic transceiver, said communication system does not transmit data acquired by said camera to said computing system.

25. A surveillance system according to claim 12, wherein said communication system compares present data collected by said camera with data previously collected by said camera to determine whether the image captured by said camera has changed, and wherein if communication system determines there is not a difference between the comparison of the two data signals, said communication system does not transmit the present data acquired by said camera to said computing system.

26. A surveillance system for use with a tractor/trailer combination comprising:
a camera located at a point of interest on the trailer of the vehicle and positioned to acquire data related to the a scene of interest of the vehicle;
a communication system associated with said camera having a transceiver for transmitting data received from said camera to a remote location; and
a computing system having an associated transceiver located in the tractor for receiving and displaying data acquired by said camera, such that a user may view the scene of interest of the vehicle from the tractor.

27. A surveillance system according to claim 26 further comprising a satellite communication system for transmitting data between said transceiver associated with the communication system and said transceiver associated with the computing system.

28. A surveillance system according to claim 26, wherein said transceivers of the communication system and computing system are connected to existing wiring in the vehicle, and wherein said transceiver communicate with each other using power line carrier communicating techniques.

29. A surveillance system according to claim 26, wherein said transceivers of the communication system and computing system are wireless and use one of radio frequency (RF) and infrared (IR) technology for communication.

30. A surveillance system according to claim 26, wherein said transceivers of the communication system and computing system are wireless and use one of BLUETOOTH and WI-FI technology for communication.
